(19) United States
(12) Patent Application Publication
(10) Pub. No.: US 2004/0042725 A1
(43) Pub. Date: Mar. 4, 2004

(54) Temperature compensating waveguide package

(76) Inventors: Dimitrii Yu Stepanov, New South Wales (AU); Fred Crous, New South Wales (AU)

Correspondence Address: BANNER & WITCOFF, 1001 G STREET N W, SUITE 1100, WASHINGTON, DC, 20001, US

(21) Appl. No.: 10/416,213

(22) PCT Filed: Nov. 16, 2001
(86) PCT No.: PCT/AU01/01494

(30) Foreign Application Priority Data
Nov. 16, 2000 (AU) PR 1512
May 4, 2001 (AU) PR 4776
May 4, 2001 (AU) PR 4775
May 4, 2001 (AU) PR 4778
Aug. 24, 2001 (AU) PR 7266

(51) Int. Cl. G02B 6/34

(52) U.S. Cl. 385/37

(57) ABSTRACT

A packaging device (10) for an optical fibre (24) is disclosed, the device comprising a first material member (12), a second material member (14), at least one lever arm (16) connectable to the fibre (24), and amounting assembly (18, 20) for rotatably mounting the lever arms (16) to at least one of the first and/or second material members, the lever arm (16) being arranged, in use, to operate under temperature induced relative movement of the first and second material members in a manner such that strain in the fibre (24) is controlled to compensate for a temperature induced change in an optical property of the fibre (24). The mounting assembly (18, 20) may include a cylindrical axis member, one or more bearing balls, or one or more protrusions or indentations formed on the lever arm (16) and at least one of the first and/or second material members.

### FIELD OF THE INVENTION

The present invention relates broadly to an optical waveguide packaging device.

The present invention will be described herein with reference to an optical fibre, and particularly with reference to a grating structure incorporated within the optical fibre. However, it will be appreciated that the present invention does have broad applications, including e.g. to planar waveguides and to other optical structures including e.g. tapered waveguide structures or modulator structures.

### BACKGROUND OF THE INVENTION

As a result of the increased utilisation of optical components in e.g. communications networks, there is a general need to provide suitable packaging devices for optical components, e.g. packaging devices for optical fibre devices. Preferably, such packaging devices also have temperature compensating characteristics to compensate for temperature induced changes in an optical property of the optical component.

In prior art packaging devices relative movement of different thermal expansion coefficient (TEC) materials is typically utilised to actuate a temperature compensating mechanism. One of the problems with proposed packaging designs of that type is that they involve forming a permanent link/bond between the different TEC materials through bonding processes such as welding. Apart from creating potential points of failure, such processes also make those designs less suitable for mass-production, in particular of multi-waveguide packages.

Also, there is a need for facilitating tuning of optical devices contained in a waveguide package to meet required specifications. In the tuning of optical components, operational tuning is initially conducted to set the operation point of the optical device, while functional tuning may then be performed to tune the optical device around the operational point.

Preferred embodiments of the present invention seek to address at least one of those general needs.

### SUMMARY OF THE INVENTION

In accordance with a first aspect of the present invention there is provided a packaging device for an optical waveguide, the device comprising a first material member, a second material member, at least one lever arm connectable to the waveguide, and a mounting assembly for connecting the lever arm to at least one of the first and/or second material members, the lever arm being arranged, in use, to operate under temperature induced relative movement of the first and second material members in a manner such that strain in the waveguide is controlled to compensate for a temperature induced change in an optical property of the waveguide, and wherein the mounting assembly is arranged, in use, for rotatably mounting the lever arm to said one material member, with a rotational axis substantially perpendicular to said one material member.

The mounting assembly may comprise a cylindrical axis member, one or more bearing balls, or one or more protrusions or indentations formed on said one material member and/or the lever arm.

The lever arm may be integrally formed with the other one of the first and second material members. A flexure may be formed between the lever arm and said other material member, for facilitating pivotal movement of the lever arm around said other material member.

In one embodiment, the first and second material members are disposed in a substantially co-extending manner.

The lever arm may be disposed in a manner such that, in use, it extends towards the waveguide from the first and second material members. Alternatively, the lever arm may be disposed in a manner such that the arm extends between the first and second materials, and the packaging device is arranged, in use, in a manner such that the waveguide is located substantially between the first and second material members.

The packaging device may comprise a pair of lever arms disposed at opposing end portions of the first and/or second material members, each lever arm of the pair being connectable to the waveguide, and a further mounting assembly for connecting the second lever arm of the pair to said one material member.

The packaging device may comprise a plurality of first material members and a plurality of lever arms, each lever arm being connectable to a corresponding one of a plurality of waveguides, and a mounting assembly for mounting the lever arms to one of the first material members and/or to the second material member, each lever arm being arranged, in use, to operate under temperature induced relative movement of one of the first material members and the second material member in a manner such that strain is induced in the corresponding waveguide to compensate for temperature induced changes in an optical property of the corresponding waveguide. The packaging device may comprise a plurality of pairs of lever arms, each lever arm of one pair being connectable to the same waveguide, and a further mounting assembly for mounting the second lever arms of the pairs to said one material member.

In preferred embodiments, the lever arm or arms are loaded to a degree chosen such that, in use over a selected temperature range, no play exists in the mounting assembly or assemblies between the lever arm or arms and said one material member.

In one embodiment, the mounting assembly or assemblies comprise corresponding pairs of protrusions and indentations formed on the lever arm or arms and said one material member. Advantageously, said other material member is flexible and, in use, bent for effecting the loading of the lever arm or arms, and the lever arm or arms move pivotally around said one material member as a result of changes in the curvature of said other material member which in turn result from the temperature induced relative movement of the material members. A flexure may be formed along the length of said other material member, for facilitating the bending of said other material member.

Preferably, the device is initially tuned to a pre-selected state by adjustment of the strain exerted by the lever arm or arms on the waveguide or waveguides for tuning of an optical structure or structures incorporated in the waveguide or waveguides.

The strain in the waveguide or waveguides may be non-reversibly adjusted by applying a transverse compressive load above a non-elastic deformation threshold to the first or/and second material members.

The lever arm or arms may be arranged, in use, to operate under a tuning means of the packaging device. The tuning means may be of a latchable or non-latchable type, i.e. requiring operation either only for switching into a different device state, or continuous operation to maintain or alter a particular device state.

The tuning means may comprise an actuator e.g. a piezo-electric member or a mechanically or electrically driven pico-motor. The actuator may be arranged, in use, to act upon at least one of the first and second material members for effecting movement of the lever arm or arms.

The waveguide may be in the form of an optical fibre.

In accordance with a second aspect of the present invention there is provided a packaging device for a plurality of optical waveguides, the device comprising a plurality of first material members, a second material member, a plurality of lever arms, each lever arm being connectable to a corresponding one of the waveguides, and a mounting assembly for mounting the lever arms to at least one of the first material members and/or to the second material member, each lever arm being arranged, in use, to operate under temperature induced relative movement of one of the first material members or the second material member in a manner such that strain is induced in the corresponding waveguide to compensate for temperature induced changes in an optical property of the corresponding waveguide.

The device may comprise a plurality of pairs of lever arms, each lever arm of one pair being connectable to the same waveguide, and a second mounting assembly for mounting the second lever arms of the pairs to said one material member.

The mounting assembly or assemblies may each comprise a plurality of mounting elements associated with different ones of the lever arms.

In accordance with a third aspect of the present invention there is provided a packaging device for an optical waveguide, the device comprising a first material member, a second material member, at least one lever arm connectable to the waveguide and a mounting assembly for connecting the lever arm to at least one of the first and second material members, the lever arm being arranged, in use, to operate under temperature induced relative movement of the first and second material members in a manner such that strain in the waveguide is controlled to compensate for a temperature induced change in an optical property of the waveguide, wherein the other material member is flexible and, in use, bent for effecting loading of the lever arm to a degree chosen such that, in use over a select temperature range, no play exists in the mounting assembly between the lever arm and said one material member, and wherein the lever arm is arranged, in use, to move pivotally around said one material member as a result of changes in the curvature of said other material member, which in turn result from the temperature induced relative movement of the material members.

The device may comprise a plurality of lever arms and a plurality of said other material members, and wherein each lever arm is arranged, in use, to move pivotally around said one material member as a result of changes in the curvature of one of said other material members, which in turn result from the temperature induced relative movement of the material members.

The device may comprise a pair or pairs of lever arms disposed at opposing end portions of the first and/or second material members, each lever arm of each pair being connectable to the or one of the waveguides, and a second mounting assembly for connecting the second lever arm or arms of the pair or pairs to said one material member.

In accordance with a fourth aspect of the present invention there is provided a packaging device structure for a plurality of optical waveguides, the device structure comprising a plurality of packaging devices in accordance with any one of the first, second, and third aspect of the present invention.

### BRIEF DESCRIPTION OF THE DRAWINGS

Preferred forms of the present invention will now be described, by way of example only, with reference to the accompanying drawings.

FIG. 1 is a schematic diagram illustrating a fibre packaging device embodying the present invention.

FIG. 2 is a schematic diagram illustrating an exploded view of another fibre packaging device embodying the present invention.

FIG. 3 is a schematic diagram illustrating another fibre packaging device embodying the present invention.

FIG. 4 is a schematic diagram illustrating another fibre packaging device embodying the present invention.

FIG. 5 is a schematic diagram illustrating another fibre packaging device embodying the present invention.

FIG. 6 is a schematic diagram illustrating another fibre packaging device embodying the present invention.

FIG. 7 is a schematic diagram illustrating another fibre packaging device embodying the present invention.

FIG. 8 is a schematic diagram illustrating another fibre packaging device embodying the present invention.

FIG. 9 is a schematic diagram illustrating another fibre packaging device embodying the present invention.

FIG. 10 is a schematic diagram illustrating another fibre packaging device embodying the present invention.

FIG. 11 is a schematic diagram illustrating another fibre packaging device embodying the present invention.

FIG. 12 is a schematic diagram illustrating another fibre packaging device embodying the present invention.

### DETAILED DESCRIPTION OF THE EMBODIMENTS

The preferred embodiments described provide temperature compensated waveguide packaging devices which do not require the formation of permanent links/bonds between different TEC material members by bonding processes such as welding.

The packaging device 10 comprises a first beam 12 formed from a high thermal expansion coefficient (TEC) material, and a second beam 14 formed from a lower TEC material. The first and second beams, 12, 14, substantially coextend one above the other.

The packaging device 10 further comprises a pair of lever arms 16. Each lever arm 16 is pivotally connected to the beam 12 (high TEC) at opposing ends thereof. The pivotal connection is effected through axis members 18.

Furthermore, each lever arm 16 is connected to the upper beam 14, (lower TEC) again at opposing ends thereof. The connection to the upper beam 14 is effected utilising axis members 20.

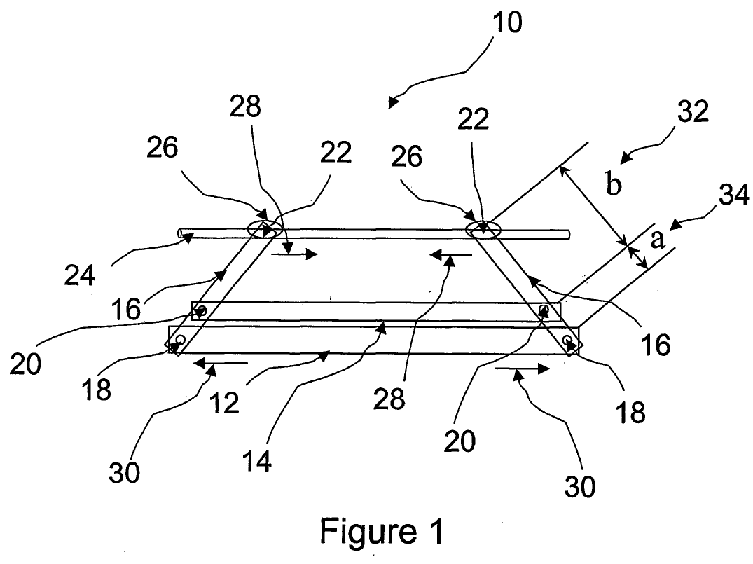

The free ends 22 of the lever arms 16 are connected to an optical fibre 24 utilising a suitable adhesive material 26. An initial tension is applied to the optical fibre 24 either prior to curing the adhesive material 26, during the curing, or afterwards. In both cases, the operational tuning of the optical structure incorporated in the waveguide is further performed by applying a transverse compressive load to beam 12 and/or beam 14 to induce permanent longitudinal deformation of the beams. In the embodiment shown in FIG. 1, the arms 16 are each inclined inwardly with respect to the coextending beams, 12, 14.

In the packaging device 10, temperature induced refractive index changes in the optical fibre 24 can be compensated for by utilising a lever mechanism operating under temperature induced relative movement between the high TEC material beam 12 and the lower TEC material beam 14.

More particularly, if a temperature increase is experienced in the ambient around the packaging device 10, a reduction in tension (indicated by arrows 28) is induced in the optical fibre 24, caused by a greater expansion of the high TEC material beam 12 (as indicated by arrows 30) compared with the lower TEC bar 14. As will be readily appreciated by a person skilled in the art, the greater expansion of beam 12 effects movement of the respective ends 22 of the arms 16 towards each other, thereby inducing the compressive strain in the optical fibre 24. Through the elasto-optic effect, the compressive strain is used to compensate for the temperature induced refractive index change in the optical fibre 24.

It will also be appreciated by the person skilled in the art, that in the packaging device 10 through suitable selection of the relevant dimensions 32, 34 in the lever mechanism, the compensating strain caused by the thermally induced relative movement between beams 12 and 14 can be chosen to suite various compensating requirements. Accordingly, the present invention can provide a versatile packaging design, which can be constructed from the same components which can be mass produced.

It is noted that as a result of the initial tensioning of the optical fibre 68 (see above), it can be ensured that during operation of the waveguide packaging device to compensate for temperature induced changes, the compressive strain exerted onto the optical fibre by the lever mechanism in case of a temperature increase will not result in any bending of the optical fibre, which would be detrimental to the device. Thus, the initial tensioning parameters are preferably appropriately chosen to accommodate temperature compensation over a given temperature range.

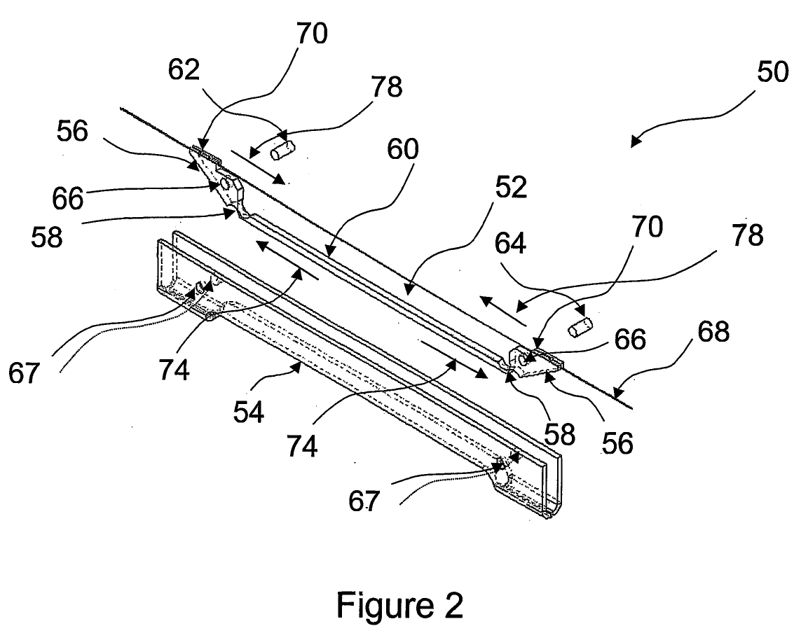

In another packaging device 50 embodying the present invention and shown in FIG. 2, a high TEC material member 52 is disposed within a U-shaped lower TEC material member 54. The high TEC material member 52 comprises two lever arm end portions 56. Flexures 58 are formed between the respective end portions 56 and a main body 60 of the high TEC material member 52. The flexing connecting portions 58 effect a pivotal connection between the lever arm end portions 56 and the main body 60 of the high TEC material member 52.

The lever arm end portions 56 are connected to the U-shaped lower TEC material member 54 by way of a mounting assembly in the form of cylinders 62, 64, received in openings 66, 67 formed in the lever arm end portions 56 and the U-shaped lower TEC material member 54 respectively.

An optical fibre 68 is mounted within grooves 70 formed in the lever arm end portions 56 by way of a suitable adhesive material.

An initial tension is applied to the optical fibre 68 either prior to curing the adhesive material, during curing, or afterwards. In both cases, the operational tuning of the optical structure incorporated in the waveguide is further performed by applying a transverse compressive load to the higher TEC member 52 to induce permanent longitudinal deformation of the beams.

In the packaging device 50, temperature induced refractive index changes in the optical fibre 68 can be compensated for by utilising a lever mechanism operating under temperature induced relative movement between the high TEC material member 52 and the lower TEC material member 54.

More particularly, if a temperature increase is experienced in the ambient around the packaging device 50, a reduction in tension (indicated by arrows 78) is induced in the optical fibre 68, caused by a greater expansion of the high TEC material member 52 (as indicated by arrows 74) compared with the lower TEC member 54. As will be readily appreciated by the person skilled in the art, the greater expansion of member 52 effects movement of the respective ends of lever arm end portions 56 towards each other, thereby inducing compressive strain in the optical fibre 68. Through the elasto-optic effect, the compressive strain is used to compensate for the temperature induced refractive index change in the optical fibre 68.

It will also be appreciated by the person skilled in the art, that in the packaging device 50 through suitable selection of the relevant dimensions in the lever mechanism, the compensating strain caused by the thermally induced relative movement between members 52 and 54 can be chosen to suite various compensating requirements. Accordingly, the present invention can provide a versatile packaging design, which can be constructed from the same components which can be mass produced.

It is noted that as a result of the initial tensioning of the optical fibre 68 (see above), it can be ensured that during operation of the waveguide packaging device to compensate for temperature induced changes, the compressive strain exerted onto the optical fibre by the lever mechanism in case of a temperature increase will not result in any bending of the optical fibre, which would be detrimental to the device. Thus, the initial tensioning parameters are preferably appropriately chosen to accommodate temperature compensation over a given temperature range.

As can be seen from FIG. 2, the design of the connection between the lever arm end portions 56 and to the U-shaped lower TEC material member 54 facilitates a package device construction in which portions of the U-shaped lower TEC material member 54 can be utilised to cover the “lever mechanism”. In the preferred embodiment shown in FIG. 2, this enables manufacturing of a more securely stackable packing device, in as much as the U-shaped lower TEC material member 54 can function as a secondary package substantially enclosing the high TEC material member 52 comprising the main body 60 and the lever arm end portions 56.

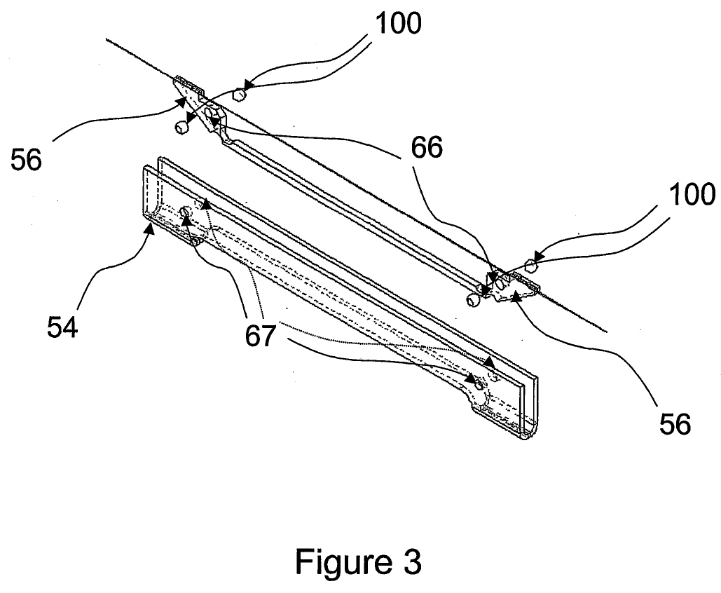

In an alternative embodiment shown in FIG. 3, axis members are provided in the form of bearing balls 100. Each bearing ball 100 is received between one of the openings 67 formed in the U-shaped lower TEC material member 54 and one of the openings 66 formed in the lever arm end portions 56.

In yet another embodiment, the lever arm end portions 56 can be rotatably mounted within the U-shaped lower TEC material member 54 by way of protrusions formed on internal walls thereof, which are received in corresponding openings formed in the lever arm end portions 56.

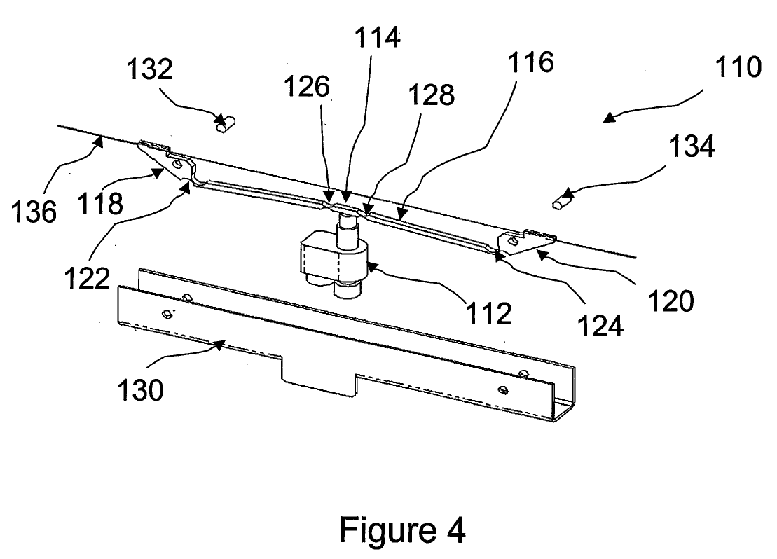

In another embodiment shown in FIG. 4, a packaging device 110 comprises a tuning means in the form of pico-motor 112 connected to a centre portion 114 of a higher TEC material member 116. The material member 116 comprises two arm portions 118, 120 pivotally connected to the main portion of the first material member 116 by way of flexures 122, 124 respectively. Two further flexures 126, 128 are formed on either side of the centre portion 114 of the material member 116.

The respective arms 118, 120 are connected to a U-shaped lower TEC material member 130 by way of axis members in the form of cylinders 132, 134.

An optical fibre 136 is mounted within grooves located at end portions of the respective arms 118, 120 by way of a suitable epoxy.

It will be appreciated by a person skilled in the art that through adjustment of the pico-motor 112, upward and downward movement of the centre portion 114 of the material member 116 will induce strain in the optical fibre 136 byway of the arm portions 118 and 120.

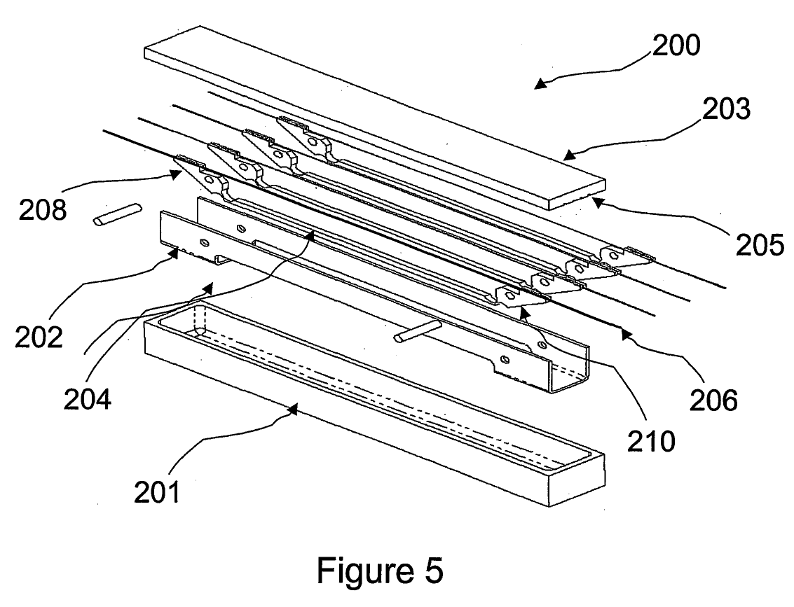

Turning now to FIG. 5, in another embodiment of the present invention a waveguide packaging device 200 comprises an widened U-shaped low TEC material member 202, with a plurality of high TEC material members, e.g. 204, mounted therein.

A plurality of optical fibres e.g. 206, are mounted between respective arm portions, e.g. 208, 210 of the material members, e.g 204. It will be appreciated by a person skilled in the art that each individual high TEC material member e.g. 204 operates in conjunction with the U-shaped low TEC material member 202 as described above with reference to the other embodiments in FIGS. 2 to 4, to provide temperature compensated packaging of the individual optical fibres e.g. 206. The packaging device 200 further comprises a dedicated secondary package structure in the form of a box 201 and corresponding lid 203. Grooves e.g. 205 are provided on the inner surface of the lid, for feed-through of the optical fibres e.g. 206. Appropriate support/feedthrough structures for the optical fibres extending from the box 201 may be provided.

Furthermore, it will be appreciated by the person skilled in the art that through variation of the configuration of the respective arm portions e.g. 208, 210, different compensation characteristics can be realised for the individual optical fibres.

In another embodiment, one or more of the high TEC material members 204 can be provided with tuning means to facilitate operational or functional tuning (compare FIG. 4 for single-fibre tunable embodiment).

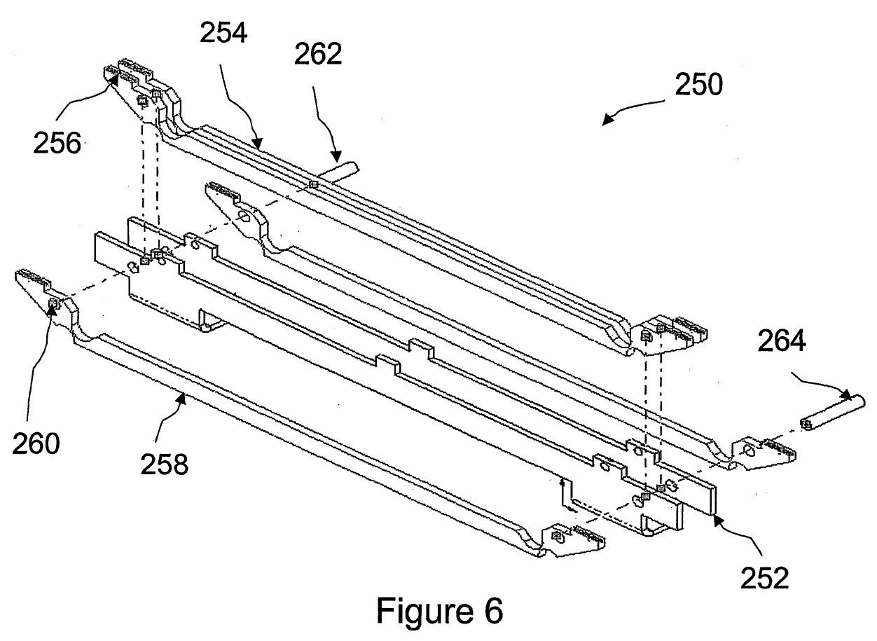

In yet another embodiment shown in FIG. 6, a packaging device 250, comprises a substantially U-shaped low TEC material member 252 enveloping only some of a plurality of high TEC material members e.g. 254 and associated lever mechanisms e.g. 256, while further high TEC material members e.g. 258 and associated lever mechanisms e.g. 260 are provided on either side outside of the U-shaped material member 252.

In such an embodiment, the axis members in the form of cylinders 262, 264 are being supported at intermediate points along their length, thereby reducing the likelihood of bending of those cylinders 262, 264 which may deteriorate the overall packaging device performance. Such an embodiment may, therefore, be particularly useful where a large number of optical fibres are to be independently mounted within the one packaging device. It is noted that overall protection/covering of the first and second material members and associated lever mechanisms can, in such embodiments, still be provided by way of a secondary package (not shown).

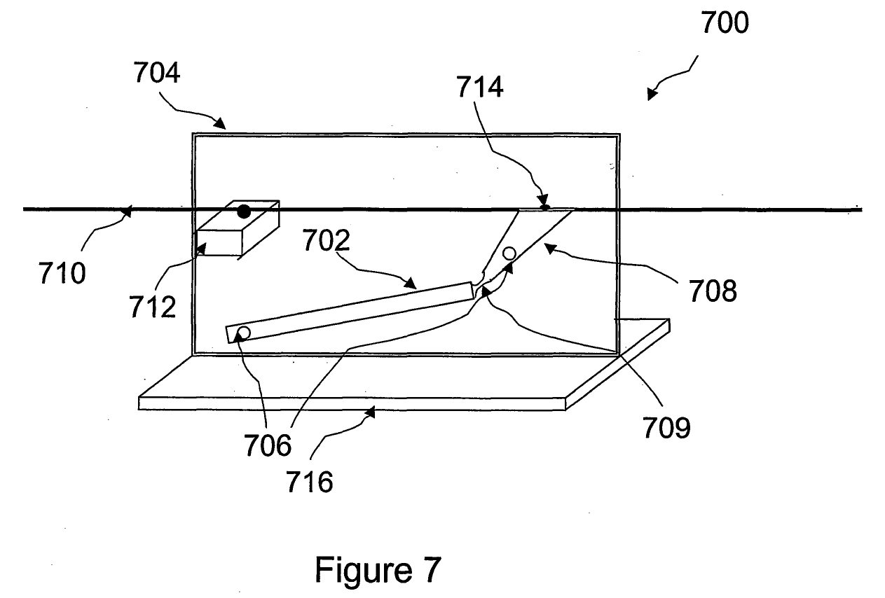

In FIG. 7, a single lever mechanism embodiment of the present invention is shown. A packaging device 700 comprises a high TEC material beam 702 connected to a low TEC material plate 704 by way of a suitable axis-type connections 706. A lever arm 708 is formed integrally with the beam 702 with a flexure 709 between the beam 702 and the lever arm 708. An optical fibre 710 is mounted between a support cantilever 712 formed on the plate 704 and the top portion 714 of the lever arm 708. A base portion 716 of the material plate 704 is utilised as a stand support for the packaging device 700. Because of the design of the connection between the lever arm 708 and the low TEC material plate 704 the lever arm 708 does not have to be connected at an end portion of the end plate 704. Therefore, the plate 704 can be extended to cover the overall lever mechanism from one side. It will be appreciated by the person skilled in the art that, in an alternative embodiment, a U-shaped “plate” can be utilised as the low TEC material member, thus enabling covering of the lever mechanism from both sides.

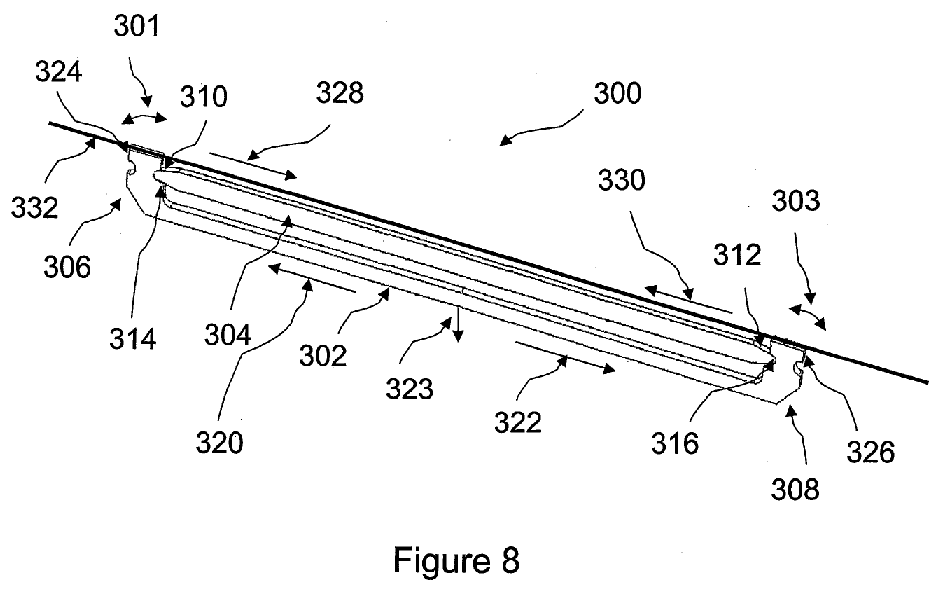

In another embodiment of the present invention shown in FIG. 8, a waveguide packaging device 300 comprises a low TEC material member 304 and a high TEC material member 302. Two lever arms 306, 308 are formed integrally with the material member 302. The mounting assembly in this embodiment comprises two wedge shaped end portions 310, 312 which engage corresponding wedge shaped indentations 314, 316 formed on the lever arms 306, 308 respectively.

The high TEC member 302 is made from an elastic material, whereby the member 302, in use, is bendable as a result of thermal extension relative to the low TEC member 304. During assembly of the waveguide packaging device 300, loading of the lever arms 306, 308 is achieved by clipping the material member 302 and with it the lever arms 306, 308 onto the low TEC material member 304, leaving a slight bend in the material member 302 effecting the loading.

The lever arms 306, 308 can turn in a bell crank-type arrangement around the low TEC member 304. An optical fibre 332 is mounted on and between top portions 324, 326 of the lever arms 306, 308 respectively by way of a suitable epoxy (not shown).

In operation, when e.g. a temperature increase is experienced, the high TEC member 302 will expand longitudinally to a larger degree than extension in that direction experienced by the low TEC member 304, as indicated by arrows 320, 322. This results in a reduction of the curvature of the material member 302 as indicated by arrow 323. As a result, the wedged lever arms 310, 312 of the member 304 will act as fulcra on which the lever arms 306, 308 turn.

Accordingly, the top portions 324, 326 of the end portions 306, 308 respectively will move towards each other, as indicated by arrows 328, 330, which results in strain being induced in the optical fibre 332 mounted on and between the top portions 324, 326. Thus, the optical properties of the optical fibre waveguide 332, which e.g. incorporates a reflection grating (not shown), can be stabilised over a selected temperature range through strain induced changes in the optical fibre waveguide 332 (and thus the reflection grating) to compensate for the temperature induced changes.

The device 300 is arranged in a manner such that the high TEC member 302 is initially loaded during assembly to a degree chosen such that, in use, over a selected temperature range, no play exists between the end portions 310, 311 and the corresponding indentations 314, 316.

Furthermore, operational tuning of the device 300 may be performed by applying a transverse compressive load above non-elastic deformation threshold to the lower TEC member 304 and/or the high TEC member 302, whereby the strain in the optical fibre 332 is non-reversibly adjusted.

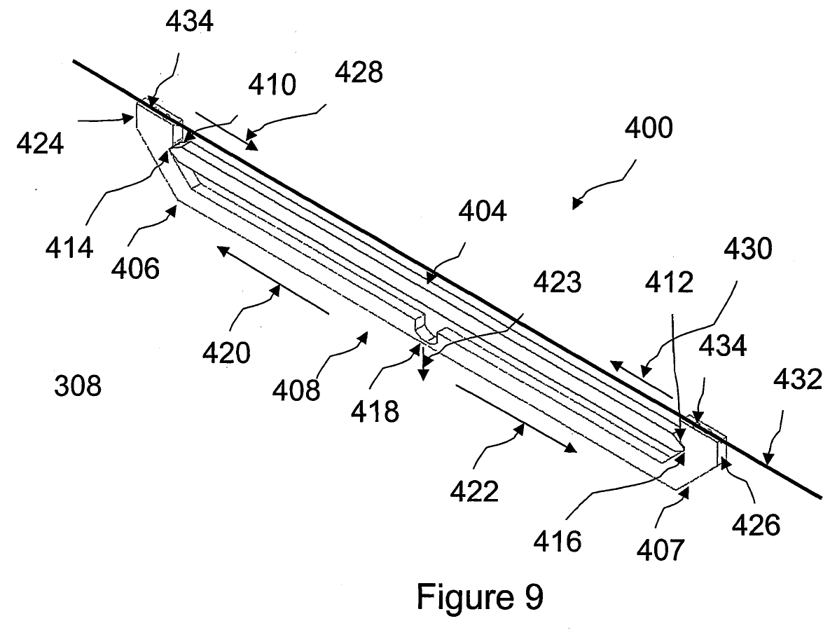

In FIG. 9, in another embodiment a waveguide packaging device 400 comprises a low TEC material member 404 and a high TEC material member 408. Two lever arms 406, 407 are integrally formed with the material member 408. The material member 404 comprises two wedge shaped end portions 410, 412 which engage corresponding wedge shaped indentations 414, 416 formed in the lever arms 406,407 respectively. A flexure 418 is formed in the middle of the material member 408. The flexure 418 facilitates bending/curving of the material member 408 for effecting loading of the lever arms 406, 407 (compare embodiment described above with reference to FIG. 8). An optical fibre 432 is mounted on and between top portions 424, 426 of the lever arms 406, 407 respectively by way of a suitable epoxy 434.

In operation, when e.g. a temperature increase is experienced, the material member 408, will extend longitudinally to a larger degree than extension in that direction experienced by the low TEC member 404, as indicated by arrows 420, 422. This results in a reduction of the bending/curvature of the material member 408 (around the flexure 418), as indicated by arrow 423. As a result, the lever arms 406, 407 turn around/on the wedge shaped end portions 410, 412 of the member 404 acting as fulcra.

Accordingly, the top portions 424, 426 of the lever arms 406, 407 respectively will move towards each other, as indicated by arrows 428, 430, which results in strain being induced in the optical fibre 432 mounted on and between the top portions 424, 426. Thus, the optical properties of the optical fibre waveguide 432, which e.g. incorporates a reflection grating (not shown), can be stabilised over a selected temperature range through strain induced changes in the optical fibre waveguide 432 (and thus the reflection grating) to compensate for the temperature induced changes.

In the embodiment shown in FIG. 9, the device 400 is arranged in a manner such that the two lever arms 406, 407 are initially loaded during assembly to a degree chosen such that, in use over a selected temperature range, no play exists between the indentations 414, 416 and the end portions 410, 412 of the low TEC member 404.

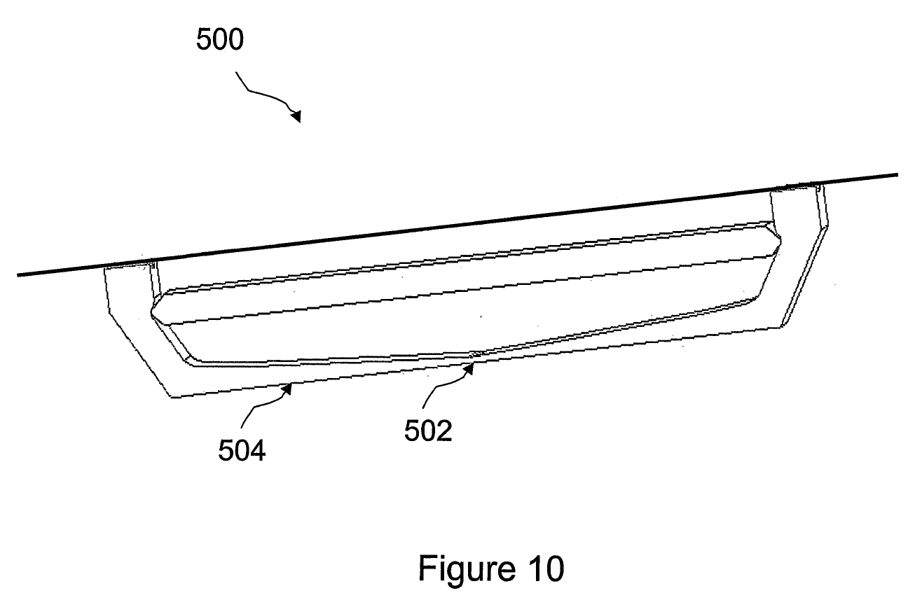

In an alternative embodiment shown in FIG. 10, a flexure 502 in/on the middle region of a high TEC material member 504 is formed by more gradually reducing the thickness of the material member 504 compared with the embodiment shown in FIG. 9.

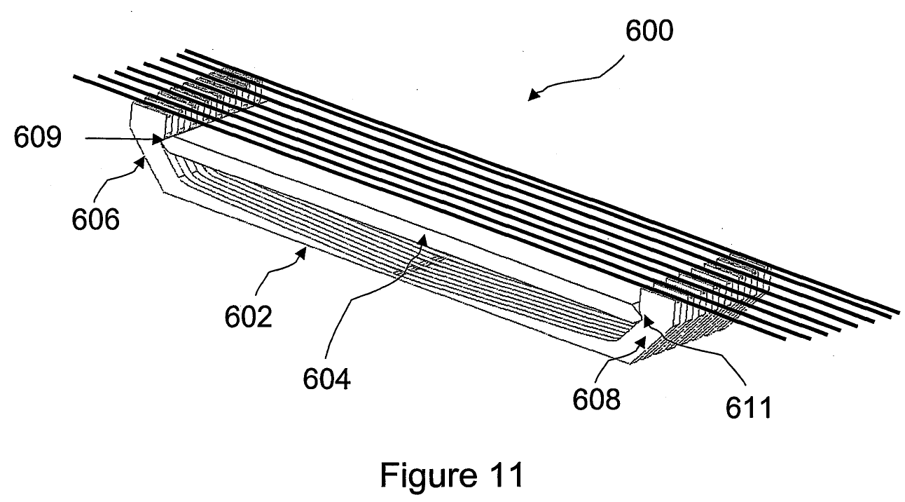

The concept of the waveguide packaging devices shown in FIGS. 8, 9 and 10 can be readily extended to a multi-waveguide packaging device 600 as shown in FIG. 11. The multi-waveguide packaging device 600 comprises a plurality of higher TEC material bellcrank-type arrangements e.g. 602, relative to a single lower TEC material member 604 extending between lever arms e.g. 606, 608 of the bellcrank-type arrangements e.g. 602.

In the waveguide packaging device 600 shown in FIG. 11, the length of the individual lever arms e.g. 606, 608 may differ to effect different compensation characteristics. The length variation may be achieved by applying a transverse compressive load above non-elastic deformation threshold to the individual lever arms e.g. 606, 608, above or below the indentations e.g. 609, 611, which engage the lower TEC material member 604. This can be effected e.g. through pinching. Alternatively, the bellcrank-type arrangements e.g. 602 may initially be manufactured with different length lever arms.

In an alternative embodiment, a multi-waveguide packaging device can comprise a plurality of lower TEC material members. In such an embodiment, each pair of lever arms cooperates with one lower TEC material member for controlling strains in a plurality of optical fibres mounted in the packaging device.

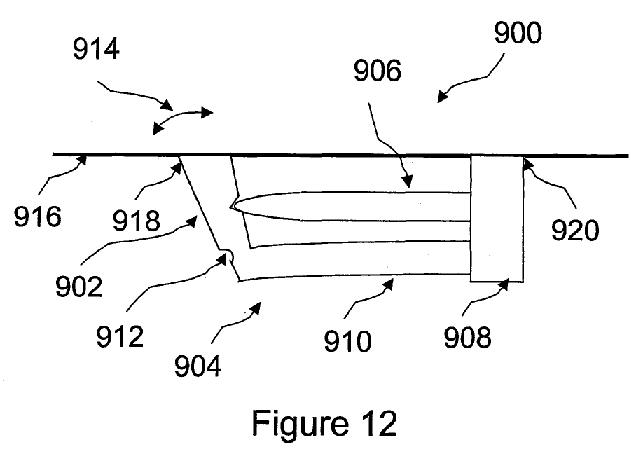

In a further embodiment shown in FIG. 12, a waveguide packaging device 900 comprises a lever arm in the form of an end portion 902 of a higher TEC material member 904. The packaging device 900 further comprises a lower TEC material member 906. Both material members 904, 906 are connected to a base portion 908 of the packaging device 900.

A flexure region 912 is formed between the end portion 902 and the longitudinal main body 910 of the material member 904, to facilitate movement (indicated by arrow 914) of the lever arm 902 under thermal expansion/contraction of the high TEC material member 904. A waveguide in the form of an optical fibre 916 is mounted in the packaging device 900 on and between a top portion 918 of the lever arm 902 and a top portion 920 of the base member 908 respectively by way of a suitable epoxy (not shown). It will be appreciated by the person skilled in the art that the operation of the waveguide packaging device 900 is generally similar to the operation of the embodiments described above with reference to FIGS. 8-11, but with a single-lever arrangement. Furthermore, it will be appreciated by the person skilled in the art that in an alternative embodiment of the present invention, a multi-waveguide packaging device comprising a plurality of single-lever arrangements can be provided.

It will be appreciated by the person skilled in the art that numerous variations and/or modifications may be made to the present invention as shown in these specific embodiments without departing from the spirit or scope of the invention as broadly described. The present embodiments are, therefore, to be considered in all respects to be illustrative and not restrictive.

E.g., where it is desired to amplify the temperature induced changes in optical properties of a waveguide mounted in a device embodying the present invention, the relative TEC properties of the different material member providing relative movement for moving the lever arms turn can be reversed compared to the embodiments described above.

In the embodiments described, the packaging devices are arranged in a manner such that the arms of the lever mechanisms are loaded to a degree chosen such that, in use over a selected temperature range, no play exists in the connection between the arm and said one material member.

One of the advantages of the present invention as embodied in the preferred embodiments described above is noted in the following. Because a mounting assembly is used to connect the lever arm to one of the material members, these typically different material components (because of the nature of the temperature compensating package design) can be rotatably/pivotally connected to each other without the need to form a direct material to material connection, such as e.g. through welding. It will be appreciated by a person skilled in the art that any direct link between the material components which at the same time provides a rotatable/pivotable connection is impractical as e.g. locating the welding line in a flexure region between the different materials would create a point of potentially high likelihood of failure.

In the claims that follow and in the summary of the invention, except where the context requires otherwise due to express language or necessary implication, the word “comprising” is used in the sense of “including”, i.e. the features specified may be associated with further features in various embodiments of the invention.

1. A packaging device for an optical waveguide, the device comprising:
a first material member,
a second material member,
at least one lever arm connectable to the waveguide, and
a mounting assembly for connecting the lever arm to at least one of the first and second material members,
the lever arm being arranged, in use, to operate under temperature induced relative movement of the first and/or second material members in a manner such that strain in the waveguide is controlled to compensate for a temperature induced change in an optical property of the waveguide, and
wherein the mounting assembly is arranged, in use, for rotatably mounting said lever arm to said one material member with a rotational axis substantially perpendicular to said one material member.

2. A device as claimed in claim 1, wherein the mounting assembly comprises a cylindrical axis member, one or more bearing balls, or one or more protrusions or indentations formed on said one material member and/or the lever arm.

3. A device as claimed in any one of the preceding claims, wherein the lever arm is integrally formed with the other one of the first and/or second material members.

4. A device as claimed in claim 3, wherein a flexure is formed between the lever arm and said other material member, for facilitating pivotal movement of the lever arm around said other material member.

5. A device as claimed in any one of the preceding claims, wherein the first and second material members are disposed in a substantially co-extending manner.

6. A device as claimed in claim 5, wherein the lever arm is disposed in a manner such that, in use, it extends towards the waveguide from the first and second material members.

7. A device as claimed in claim 5, wherein the lever arm is disposed in a manner such that the arm extends between the first and second materials, and the packaging device is arranged, in use, in a manner such that the waveguide is located substantially between the first and second material members.

8. A device as claimed in any one of the preceding claims, wherein the device comprises a pair of lever arms disposed at opposing end portions of the first and/or second material members, each lever arm of the pair being connectable to the waveguide, and a second mounting assembly for connecting the second lever arm of the pair to said one material member.

9. A device as claimed in any one of claims 1 to 7, wherein the device comprises:
a plurality of first material members and
a plurality of lever arms, each lever arm being connectable to a corresponding one of a plurality of waveguides, and
a mounting assembly for mounting the lever arms to one of the first material members and/or to the second material member,
each lever arm being arranged, in use, to operate under temperature induced relative movement of one of the first material members and the second material member in a manner such that strain is induced in the corresponding waveguide to compensate for temperature induced changes in an optical property of the corresponding waveguide.

10. A device as claimed in claim 9, wherein the device comprises a plurality of pairs of-lever arms, each lever arm of one pair being connectable to the same waveguide, and a second mounting assembly for mounting the second lever arms of the pairs to said one material member.

11. A device as claimed in any one of the preceding claims, wherein the lever arm or arms are loaded to a degree chosen such that, in use over a selected temperature range, no play exists in the mounting assembly or assemblies between the lever arm or arms and said one material member.

12. A device as claimed in claim 11, wherein the mounting assembly or assemblies comprise corresponding pairs of protrusions and indentations formed on the lever arm or arms and said one material member.

13. A device as claimed in claim 12, wherein said other material member is flexible and, in use, bent for effecting the loading of the lever arm or arms, and wherein the lever arm or arms move pivotally around said one material member as a result of changes in the curvature of said other material member, which in turn result from the temperature induced relative movement of the material members.

14. A device as claimed in claim 13, wherein a flexure is formed along the length of said other material member, for facilitating the bending of said other material member.

15. A device as claimed in any one of the preceding claims, wherein the device is initially tuned to a pre-selected state by adjustment of the strain exerted by the lever arm or arms on the waveguide or waveguides for tuning of an optical structure or structures incorporated in the waveguide or waveguides.

16. A device as claimed in claim 15, wherein the strain in the waveguide or waveguides is non-reversibly adjusted by applying a transverse compressive load above a non-elastic deformation threshold to the first or/and second material members.

17. A device as claimed in any one of the preceding claims, wherein the lever arm or arms may be arranged, in use, to operate under a tuning means of the device.

18. A device as claimed in claim 17, wherein the tuning means is of a latchable or non-latchable type.

19. A device as claimed in claims 17 or 18, wherein the tuning means comprises an actuator.

20. A device as claimed in claim 19, wherein the actuator is arranged, in use, to act on at least one of the first and second material members for effecting movement of the lever arm or arms for tuning.

21. A device as claimed in claims 19 or 20, wherein the actuator comprises a piezoelectric member or a mechanically or electrically driven pico-motor.

22. A device as claimed in any one of the preceding claims, wherein the waveguide is in the form of an optical fibre.

23. A packaging device for a plurality of optical waveguides, the device comprising:
a plurality of first material members,
a second material member,
a plurality of lever arms, each lever arm being connectable to a corresponding one of the waveguides, and
a first mounting assembly for mounting the lever arms to at least one of the first material members and/or to the second material member,
each lever arm being arranged, in use, to operate under temperature induced relative movement of one of the first material members or the second material member in a manner such that strain is induced in the corresponding waveguide to compensate for temperature induced changes in an optical property of the corresponding waveguide.

24. A device as claimed in claim 23, wherein the device comprises a plurality of pairs of lever arms, each lever arm of one pair being connectable to the same waveguide, and a second mounting assembly for mounting the second lever arms of the pairs to said one material member.

25. A device as claimed in claims 23 or 24, wherein the mounting assembly or assemblies each comprise a plurality of mounting elements associated with different ones of the lever arms.

26. A packaging device for an optical waveguide, the device comprising:
a first material member,
a second material member,
at least one lever arm connectable to the waveguide and
a first mounting assembly for connecting the lever arm to at least one of the first and/or second material members,
the lever arm being arranged, in use, to operate under temperature induced relative movement of the first and second material members in a manner such that strain in the waveguide is controlled to compensate for a temperature induced change in an optical property of the waveguide,
wherein the other material member is flexible and, in use, bent for effecting loading of the lever arm to a degree chosen such that, in use over a select temperature range, no play exists in the mounting assembly between the lever arm and said one material member, and
wherein the lever arm is arranged, in use, to move pivotally around said one material member as a result of changes in the curvature of said other material member, which in turn result from the temperature induced relative movement of the material members.

27. A device as claimed in claim 26, wherein the device comprises a plurality of lever arms and a plurality of said other material members, and wherein each lever arm is arranged, in use, to move pivotally around said one material member as a result of changes in the curvature of one of said other material members, which in turn result from the temperature induced relative movement of the material members.

28. A device as claimed in claims 26 or 27, wherein the device comprises a pair or pairs of lever arms disposed at opposing end portions of the first and/or second material members, each lever arm of each pair being connectable to the or one of the waveguides, and a second mounting assembly for connecting the second lever arm or arms of the pair or pairs to said one material member.

29. A packaging device structure for a plurality of optical waveguides, the device structure comprising a plurality of packaging devices as claimed in any one of the preceding claims.
